(19) United States
(12) Patent Application Publication
(10) Pub. No.: US 2012/0105753 A1
(43) Pub. Date: May 3, 2012

(54) LIQUID CRYSTAL LENS ARRAY DEVICE, DRIVING METHOD THEREOF AND IMAGE DISPLAY DEVICE

(75) Inventors: Sho Sakamoto, Tokyo (JP); Chiaki Kanai, Kanagawa (JP); Yoshihisa Sato, Saitama (JP); Kenichi Takahashi, Kanagawa (JP)

(73) Assignee: SONY CORPORATION, Tokyo (JP)

(21) Appl. No.: 13/269,094

(22) Filed: Oct. 7, 2011

(30) Foreign Application Priority Data
Oct. 29, 2010 (JP) 2010-244320

(51) Int. Cl. G02F 1/133

(52) U.S. Cl. 349/33; 349/200

(57) ABSTRACT

A liquid crystal lens array device includes: a first electrode; a plurality of second electrodes arranged to face the first electrode, to which drive voltages having waveforms with phase differences therebetween are applied; and a liquid crystal layer arranged between the first electrode and the plural second electrodes, generating lens effects in accordance with potential differences between the drive voltage applied to the first electrode and drive voltages applied to the plural second electrodes.

### CROSS REFERENCES TO RELATED APPLICATIONS

The present application claims priority to Japanese Priority Patent Application JP 2010-244320 filed in the Japan Patent Office on Oct. 29, 2010, the entire content of which is hereby incorporated by reference.

### BACKGROUND

The present application relates to a liquid crystal lens array device generating lens effects, a driving method thereof and an image display device performing image display by using the liquid crystal lens array device.

As one of principal methods of liquid crystal lenses generating lens effects by using liquid crystal, there is a method in which electric field distribution is generated by using patterned electrodes to thereby obtain lens effects. In this method, electric field distribution is generated by filling liquid crystal between facing substrates and giving different potential differences to electrodes wired in respective substrates. As liquid crystal molecules are arranged with anisotropy along the electric field distribution, refractive index distribution is generated and lens effects can be obtained. That is, when the electric field distribution to be generated is accurately controlled, desired refractive index distribution can be realized as well as desired lens performance can be obtained.

FIG. 18 shows a structure example of a liquid crystal lens array device in related art. In the liquid crystal lens array device, a first substrate 110 on which a first electrode 111 is provided and a second substrate 120 on which second electrodes 121 are provided are arranged to face each other with a liquid crystal layer 130 sandwiched therebetween. The most common electrode structure is a structure in which plural second electrodes 121 are arranged in parallel as line electrodes and the first electrode 111 is arranged as a planar electrode. In such structure, for example, two line electrodes A, B in plural second electrodes 121 are driven in combination. In this case, the same waveform having certain amplitude and frequency is applied to the electrode A and the electrode B (a drive voltage without phase difference is applied) as shown in FIGS. 19A and 19B. A planar electrode C as the first electrode 111 in this case has a ground potential as shown in FIG. 19C. In this case, a potential difference is generated between the electrode A and the electrode C in the vertical direction and an electric field is generated. The electric field is also generated between the electrode B and the electrode C, therefore, lens effects are generated between the electrode A and the electrode B, as a result, an device equivalent to a lens is formed.

### SUMMARY

When the electric field distribution generated as described above is ideal distribution as shown in FIG. 20, smooth and neat refractive index distribution can be obtained and a liquid crystal lens having high lens performance can be realized. However, in the case of the simple electrode structure as shown in FIG. 18, a state shown in FIG. 21 is liable to occur, in which the electric field steeply changes just under the electrodes A, B or in the vicinity of them and the electric field hardly changes in an intermediate position between the electrode A and the electrode B. In this case, the refractive index steeply changes in the vicinity of the electrodes A, B and strong lens effects can be obtained, however, the refractive index hardly changes in the intermediate position between the electrode A and the electrode B and effects as the lens can hardly be obtained. Such state is liable to occur when the liquid crystal layer is thin (the aspect ratio is high). The electric field distribution may be smooth when the liquid crystal layer is made thick, however, there are problems such that quantity of liquid crystal is increased (cost increase), that response speed is reduced and that it is necessary to increase voltage to be applied.

Some countermeasures against the above problems can be cited. For example, there is a method in which plural line electrodes are further wired between the electrode A and the electrode B and different voltages are applied to respective line electrodes to thereby obtain smooth electric field distribution. There is also another method in which a layer of electrodes is further provided to be a three-layer structure (refer to JP-A-2008-9370 (Patent Document 1)). The method is realized by arranging one more sheet of glass on the electrodes A, B and forming electrodes on the surface thereof, or by forming line electrodes on both surfaces of one substrate. The degree of freedom in voltage application is increased by the method to thereby make electric field distribution smooth and improve lens performance. However, these methods may cause problems such that wiring and drive circuits are complicated or that processes are complicated.

In view of the above, it is desirable to provide a liquid crystal lens array device capable of improving lens effects without complicating the structure, a driving method thereof and an image display device.

An embodiment is directed to a liquid crystal lens array device including a first electrode, a plurality of second electrodes arranged to face the first electrode, to which drive voltages having waveforms with phase differences therebetween are applied and a liquid crystal layer arranged between the first electrode and the plural second electrodes, generating lens effects in accordance with potential differences between the drive voltage applied to the first electrode and drive voltages applied to the plural second electrodes.

Another embodiment is directed to a method of driving the liquid crystal lens array device having a first electrode, a plurality of second electrodes arranged to face the first electrode, and a liquid crystal layer arranged between the first electrode and the plural second electrodes, generating lens effects in accordance with potential differences between the drive voltage applied to the first electrode and drive voltages applied to the plural second electrodes, which applies drive voltages having waveforms with phase differences therebetween to the respective plural second electrodes.

Still another embodiment is directed to an image display device including a display unit, and a liquid crystal lens array device arranged to face the display unit. The liquid crystal lens array device is configured by using the liquid crystal lens array device according to the embodiment.

In the liquid crystal lens array device, the driving method thereof and the image display device according to the embodiments, lens effects are generated in accordance with potential differences between the drive voltage applied to the first electrode and drive voltages applied to the plural second electrodes. To the plural second electrodes, drive voltages having waveforms with phase difference therebetween are applied. Accordingly, potential differences are generated not only between the first electrode and the second electrodes but also between plural second electrodes.

The drive voltages having waveforms with phase differences therebetween are applied to plural second electrodes in the liquid crystal lens array device, the driving method thereof and the image display device according to the embodiment, therefore, potential differences can be generated not only between the first electrode and the second electrodes which face to each other but also between plural second electrodes. Accordingly, the electric field distribution can be controlled not only in the facing direction but also in a plane direction, therefore, lens performance can be improved without complicating the structure.

Additional features and advantages are described herein, and will be apparent from the following Detailed Description and the figures.

### BRIEF DESCRIPTION OF THE FIGURES

FIG. 1A is a cross-sectional view showing a structure example of a liquid crystal array device according to a first embodiment, and FIG. 1B is an explanatory view equivalently showing lens effects generated by the liquid crystal lens array device;

FIG. 2A is an explanatory view schematically showing electric field distribution when the liquid crystal lens array device shown in FIG. 1A is driven in a first drive example, FIG. 2B is a waveform diagram showing a drive waveform applied to an electrode A when driven in the first drive example, FIG. 2C is a waveform diagram showing a drive waveform applied to an electrode B when driven in the first drive example and FIG. 2D is a waveform diagram showing potential differences between the electrode A and the electrode B when driven in the first drive example;

FIG. 3A is an explanatory view schematically showing electric field distribution when the liquid crystal lens array device shown in FIG. 1A is driven in a second drive example, FIG. 3B is a waveform diagram showing a drive waveform applied to an electrode A when driven in the second drive example, FIG. 3C is a waveform diagram showing a drive waveform applied to an electrode B when driven in the second drive example and FIG. 3D is a waveform diagram showing potential differences between the electrode A and the electrode B driven in the second drive example;

FIG. 4A is an explanatory view schematically showing electric field distribution when the liquid crystal lens array device shown in FIG. 1A is driven in a third drive example, FIG. 4B is a waveform diagram showing a drive waveform applied to an electrode A when driven in the third drive example, FIG. 4C is a waveform diagram showing a drive waveform applied to an electrode B when driven in the third drive example and FIG. 4D is a waveform diagram showing potential differences between the electrode A and the electrode B driven in the third drive example;

FIG. 5 is a cross-sectional diagram schematically showing electric field distribution when the electric field in a horizontal direction is made higher in the liquid crystal array device shown in FIG. 1A;

FIG. 6 is a cross-sectional view showing an example of a lenticular-type 3D image display device;

FIG. 7A is an explanatory view schematically showing electric field distribution when a liquid crystal lens array device according to a second embodiment is driven in a first drive example, FIG. 7B is a waveform diagram showing a drive waveform applied to an electrode A when driven in the first drive example, FIG. 7C is a waveform diagram showing a drive waveform applied to an electrode B when driven in the first drive example and FIG. 7D is a waveform diagram showing a drive waveform applied to an electrode C when driven in the first drive example;

FIG. 8A is an explanatory view schematically showing electric field distribution when a liquid crystal lens array device according to the second embodiment is driven in a second drive example, FIG. 8B is a waveform diagram showing a drive waveform applied to an electrode A when driven in the second drive example, FIG. 8C is a waveform diagram showing a drive waveform applied to an electrode B when driven in the second drive example and FIG. 8D is a waveform diagram showing a drive waveform applied to the electrode C when driven in the second drive example;

FIG. 9A is an explanatory view schematically showing electric field distribution when a liquid crystal lens array device according to the second embodiment is driven in a third drive example, FIG. 9B is a waveform diagram showing a drive waveform applied to an electrode A when driven in the third drive example, FIG. 9C is a waveform diagram showing a drive waveform applied to an electrode B when driven in the third drive example and FIG. 9D is a waveform diagram showing a drive waveform applied to the electrode C when driven in the third drive example;

FIG. 10 is a cross-sectional view showing a structure example of a liquid crystal lens array device according to a third embodiment with electric field distribution obtained when driven in a first drive example;

FIGS. 11A to 11G are waveform diagrams showing drive waveforms applied to respective electrodes when the liquid crystal lens array device according to the third embodiment is driven in the first drive example;

FIGS. 12A to 12F are waveform diagrams showing potential differences generated between two electrodes in a vertical direction when the liquid crystal lens array device according to the third embodiment is driven in the first drive example;

FIGS. 13A to 13E are waveform diagrams showing potential differences generated between two electrodes in the horizontal direction when the liquid crystal lens array device according to the third embodiment is driven in the first drive example;

FIG. 14 is a cross-sectional view showing a structure example of a liquid crystal lens array device according to the third embodiment with electric field distribution obtained when driven in a second drive example;

FIGS. 15A to 15G are waveform diagrams showing drive waveforms applied to respective electrodes when the liquid crystal lens array device according to the third embodiment is driven in the second drive example;

FIGS. 16A to 16F are waveform diagrams showing potential differences generated between two electrodes in the vertical direction when the liquid crystal lens array device according to the third embodiment is driven in the second drive example;

FIGS. 17A to 17E are waveform diagrams showing potential differences generated between two electrodes in the horizontal direction when the liquid crystal lens array device according to the third embodiment is driven in the second drive example;

FIG. 18 is a cross-sectional view showing a structure example of a liquid crystal lens array device in related art;

FIG. 19A is a waveform diagram showing a drive waveform applied to an electrode A when driven in a related-art drive example, FIG. 19B is a waveform diagram showing a drive waveform applied to an electrode B when driven in the related-art drive example and FIG. 19C is a waveform diagram showing a drive waveform applied to an electrode C when driven in the related-art drive example;

FIG. 20 is a cross-sectional view specifically showing an example of ideal electric field distribution; and

FIG. 21 is a cross-sectional view specifically showing an example deviated from an ideal state.

### DETAILED DESCRIPTION

Embodiments of the present application will be described below in detail with reference to the drawings.

### First Embodiment

Structure of Liquid Crystal Lens Array

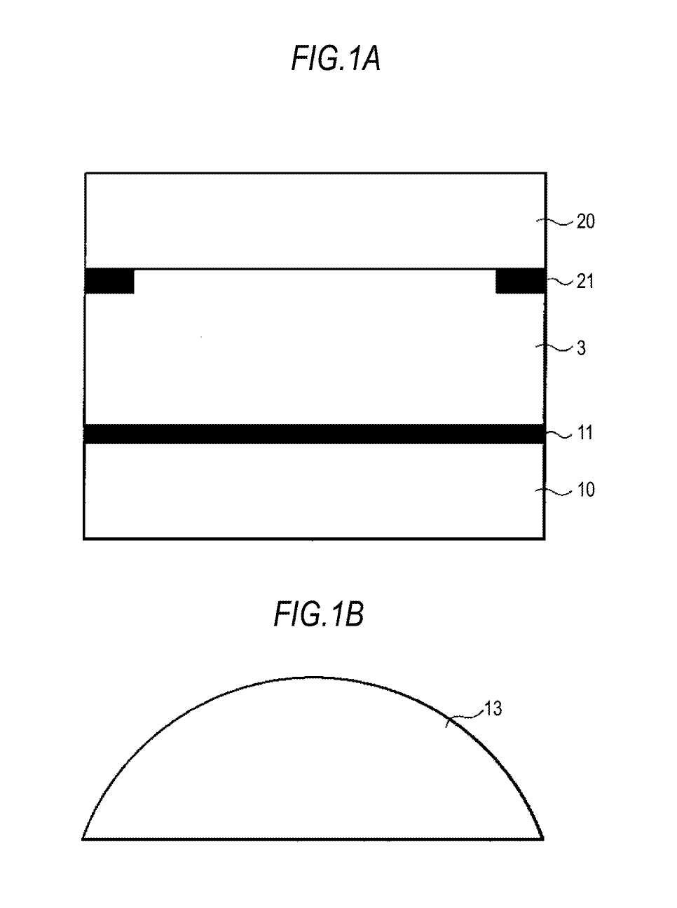

FIG. 1A shows a structure example of a liquid crystal lens array device according to a first embodiment. The liquid crystal lens array device includes a first substrate 10 and a second substrate 20 arranged to face each other with a gap therebetween as well as a liquid crystal layer 3 arranged between the first substrate 10 and the second substrate 20. The first substrate 10 and the second substrate 20 are transparent substrates made of, for example, a glass material or a resin material. A first electrode 11 made of a transparent conductive film such as an ITO film is formed on almost the whole surface of the first substrate 10 on a side facing the second substrate 20. On the first substrate 10, a first alignment film is also formed so as to touch the liquid crystal layer 3 through the first electrode 11, though not shown. Second electrodes 21 made of the transparent conductive film such as the ITO film are formed partially on the second substrate 20 on a side facing the first substrate 10. On the second substrate 20, a second alignment film is also formed so as to touch the liquid crystal layer 3 through the second electrodes 21, though not shown.

The liquid crystal layer 3 have liquid crystal molecules having refractive index anisotropy, in which an alignment direction of liquid crystal molecules is changed in accordance with potential differences between a drive voltage applied on the first electrode 11 and drive voltages applied on the second electrodes 21 to thereby control lens effects. The liquid crystal molecules included in the liquid crystal layer 3 has a structure of, for example, a refractive index ellipsoid having different refractive indexes in a long-side direction and a short-side direction with respect to transmitted light.

The first electrode 11 is a planar-type electrode views as a whole. The second electrodes 21 are formed as two line electrodes arranged with a gap therebetween, extending along in the direction vertical to a paper of FIG. 1A. When drive voltages having later-described drive waveforms are applied to the first electrode 11 and the plural second electrodes 21 respectively, electric field distribution in the liquid crystal layer 3 is biased. Accordingly, lens effects (refractive power) equivalent to a cylindrical lens 13 shown in FIG. 1B can be generated.

Specific Examples of Drive Waveforms

### First Drive Example

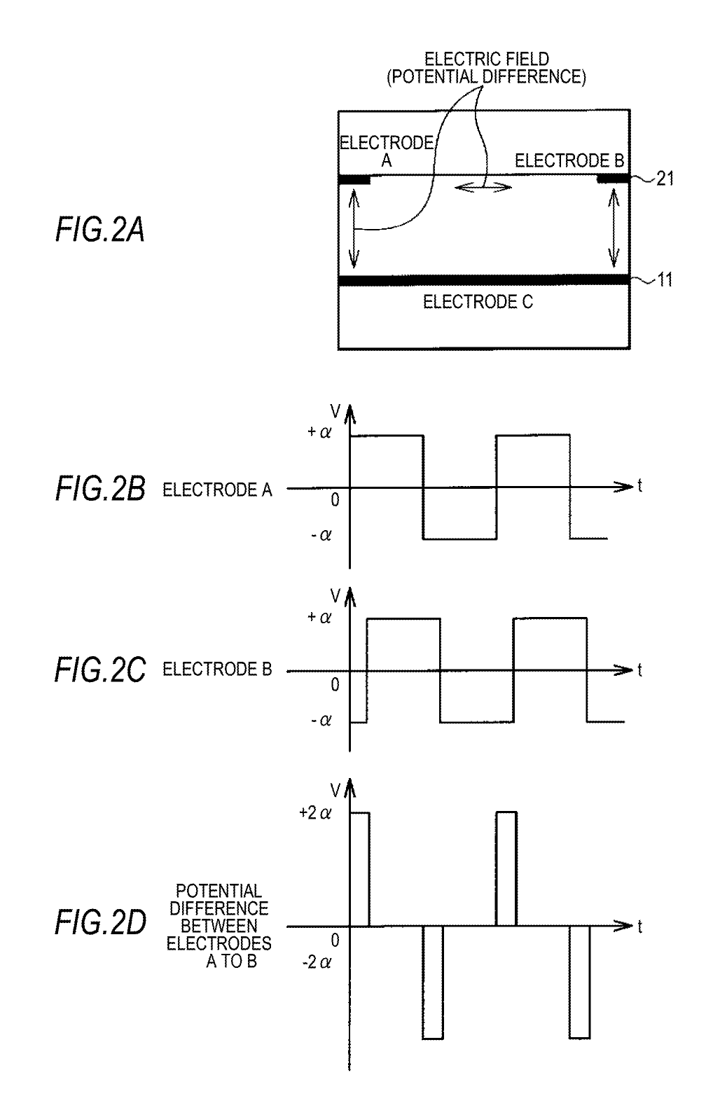

FIG. 2A schematically shows electric field distribution (potential difference distribution) obtained when the liquid crystal lens array device shown in FIG. 1A is driven in a first drive example. FIG. 2A schematically shows that the thinner and shorter an arrow is, the lower the intensity of the electric field (potential difference) is, conversely, that the thicker and longer an arrow is, the higher the intensity of the electric field (potential difference) is. In FIG. 2A, the first electrode 11 is represented by an electrode C and the two line electrodes formed as the second electrodes 21 are represented by an electrode A and an electrode B. FIG. 2B shows a drive waveform applied to the electrode A when driven in the first drive example and FIG. 2C shows a drive waveform applied to the electrode B when driven in the first drive example. FIG. 2D shows a potential difference between the electrode A and the electrode B when driven in the first drive example. The electrode C has a fixed potential (ground potential).

In the first drive example, drive voltages of rectangular waves having an amplitude of ±α(V) are applied to the electrode A and the electrode B respectively. The first drive example is an example in which the drive voltage a phase of which is shifted by 45 degrees with respect to the drive voltage of the electrode A is applied to the electrode B as shown in FIGS. 2B and 2C. In the first drive example, a potential difference of 2αV is generated between the electrode A and the electrode B in periods in which phases are reversed between the electrode A and the electrode B as shown in FIG. 2D. The potential difference between the electrode A and the electrode B is 0V in periods in which the phases are the same.

### Second Drive Example

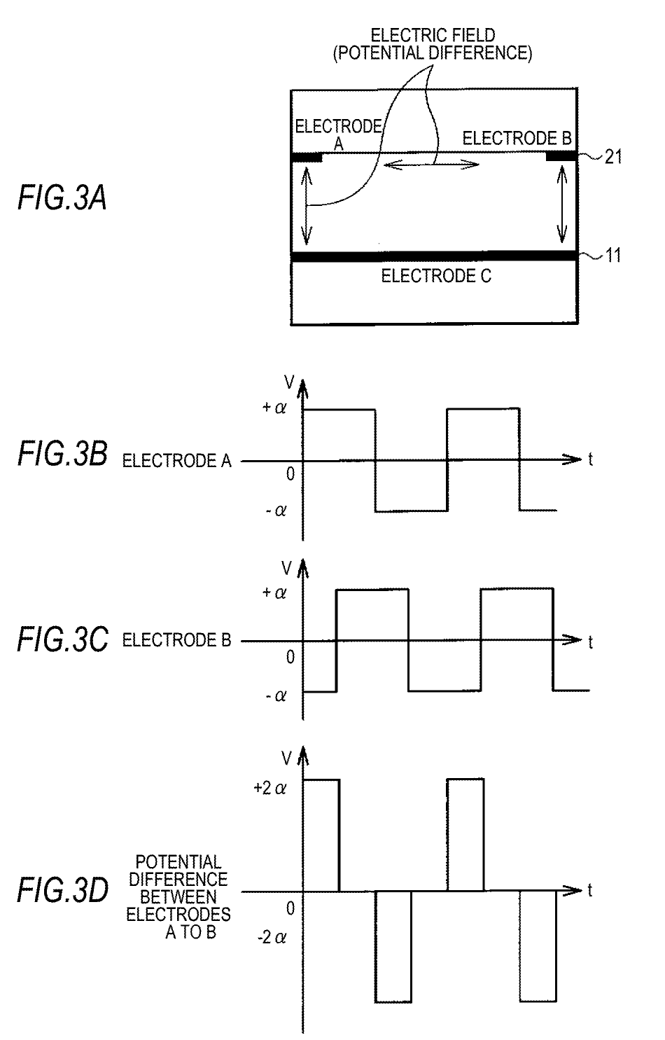

FIG. 3A schematically shows electric field distribution (potential difference distribution) obtained when the liquid crystal lens array device shown in FIG. 1A is driven in a second drive example in the same manner as FIG. 2A. FIG. 3B shows a drive waveform applied to the electrode A when driven in the second drive example and FIG. 3C shows a drive waveform applied to the electrode B when driven in the second drive example. FIG. 3D shows potential differences between the electrode A and the electrode B when driven in the second drive example. The electrode C has the fixed potential (ground potential).

In the second drive example, drive voltages of rectangular waves having the amplitude of ±α(V) are applied to the electrode A and the electrode B respectively. The second drive example is an example in which the drive voltage a phase of which is shifted by 90 degrees with respect to the drive voltage of the electrode A is applied to the electrode B as shown in FIGS. 3B and 3C. In the second drive example, the potential difference of 2αV is generated between the electrode A and the electrode B in periods in which phases are reversed between the electrode A and the electrode B as shown in FIG. 3D. The potential difference between the electrode A and the electrode B is 0V in periods in which the phases are the same. In the second drive example, the period of the reversed phases is increased as compared with the first drive example, therefore, the electric field in the horizontal direction is to be higher than the first drive example.

### Third Drive Example

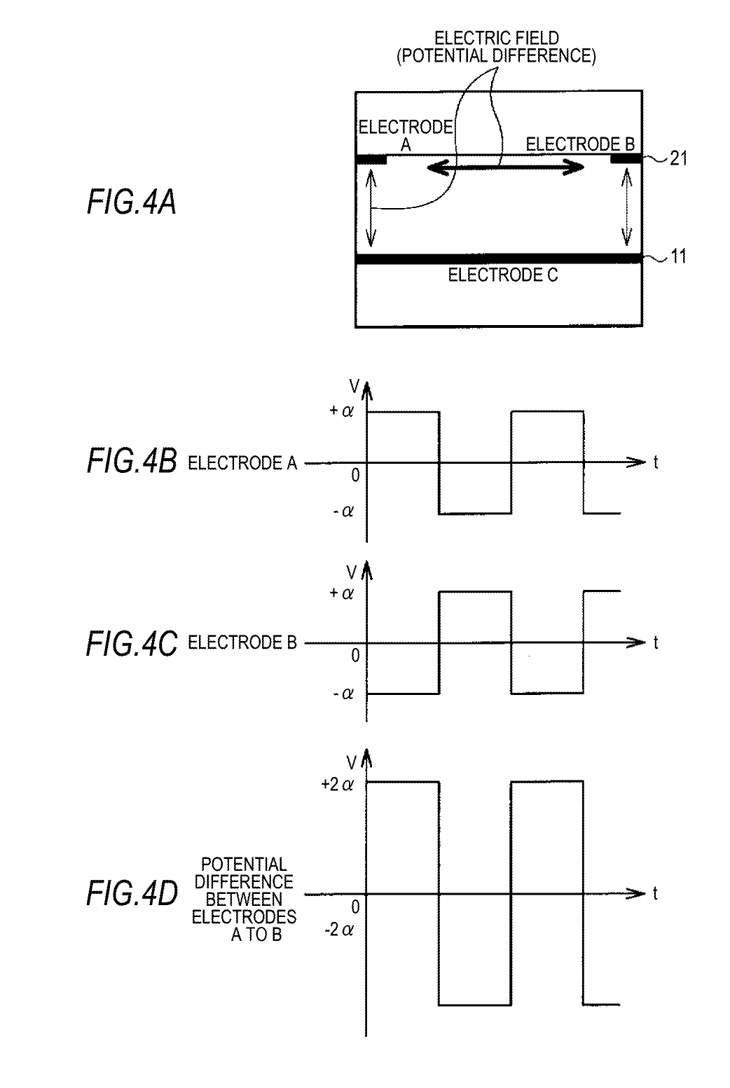

FIG. 4A schematically shows electric field distribution (potential difference distribution) obtained when the liquid crystal lens array device shown in FIG. 1A is driven in a third drive example in the same manner as FIG. 2A. FIG. 4B shows a drive waveform applied to the electrode A when driven in the third drive example and FIG. 4C shows a drive waveform applied to the electrode B when driven in the third drive example. FIG. 4D shows potential differences between the electrode A and the electrode B when driven in the third drive example. The electrode C has the fixed potential (ground potential).

In the third drive example, drive voltages of rectangular waves having the amplitude of ±α(V) are applied to the electrode A and the electrode B respectively. The third drive example is an example in which the drive voltage a phase of which is shifted by 180 degrees with respect to the drive voltage of the electrode A is applied to the electrode B as shown in FIGS. 4B and 4C. In the third drive example, a potential difference of 2αV is generated between the electrode A and the electrode B in periods in which phases are reversed between the electrode A and the electrode B as shown in FIG. 4D. The potential difference between the electrode A and the electrode B is 0V in periods in which the phases are the same. In the third drive example, the period of the reversed phases is further increased as compared with the second drive example, therefore, the electric field in the horizontal direction is to be further higher than the first drive example and the second drive example. The electric field in the horizontal direction is the highest in the case where the phase shift is 180 degrees as the third drive example.

As can be seen from the above respective drive examples, the electric field distribution in the horizontal direction can be changed by changing a phase difference between the electrode A and the electrode B.

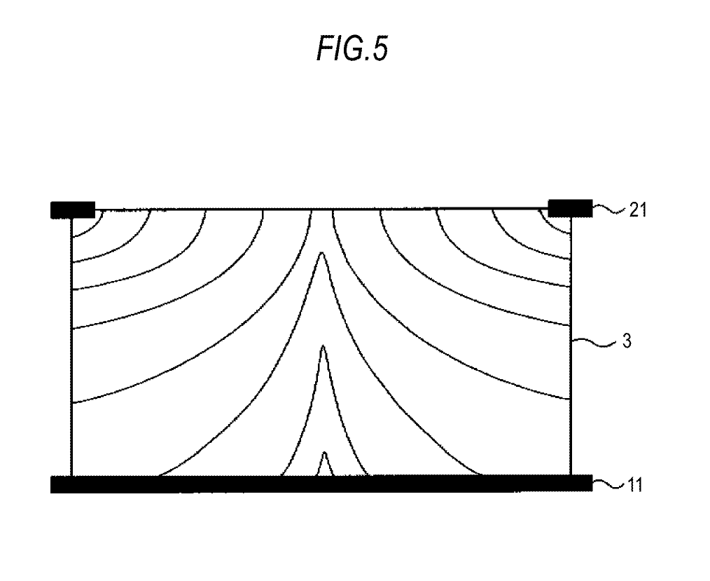

When the device is actually driven at some high frequencies, liquid crystal molecules are not actually moved in response to the frequency but induced polarization occurs in liquid crystal. Therefore, it is conceivable that alignment of liquid crystal is settled in the electric field distribution in a state where changes of generated electric fields are integrated. Accordingly, the electric field in the horizontal direction can be controlled by changing the phase difference as shown in FIGS. 2A to 2D to FIGS. 4A to 4D. In this case, when the electric field in the horizon direction is too high, the electric field distribution will be the one in which the electric field steeply changes in the horizontal direction of the line electrodes as shown in FIG. 5, which is different from, for example, the ideal electric field distribution of FIG. 20. Therefore, it is important to adjust the balance of electric fields in the vertical direction and the horizontal direction to realize the optimum electric field distribution. Naturally, amplitude is also one of adjustment factors in this case.

As explained above, drive voltages having waveforms with the phase difference therebetween are applied to plural second electrodes 21 in the liquid crystal lens array device according to the embodiment, therefore, the potential difference can be generated not only between the first electrode 11 and the second electrode 21 which face each other but also between plural second electrodes 21. Accordingly, the electric field distribution can be controlled not only in the facing direction but also in a plane direction (horizontal direction), therefore, it is possible to smooth the electric field distribution and improve lens performance without using a large number of electrodes or complicating the structure of a liquid crystal cell. Additionally, the liquid crystal layer as well as the liquid crystal cell can be thinner, which realizes cost reduction, speeding-up of response speed and low-voltage driving.

Application Examples to a 3D Image Display Device

The liquid crystal lens array device according to the embodiment can be applied to, for example, a lenticular-type 3D image display device as shown in FIG. 6. The 3D image display device of FIG. 6 includes a lenticular lens 1A and an image display device 2. The lenticular lens 1A has plural split lenses functioning as plural parallax separation units. Each of the split lenses is the cylindrical lens 13 extending in a given direction.

The image display device 2 includes a two-dimensional display such as a liquid crystal display panel, an electroluminescence display panel or a plasma display. On a display screen of the image display device, plural pixels are arranged two-dimensionally in the horizontal direction and the vertical direction, in which one pixel includes m-pieces of (“m” is an integer of 1 or more) sub-pixels. For example, an R (red) sub-pixel, a G (green) sub-pixel and a B (blue) sub-pixel are arranged by turns in the horizontal direction, and the sub-pixels of the same color are arranged in the vertical direction. On the pixel display device 2, parallax images for plural viewpoints are allocated to respective sub-pixels in a given arrangement pattern to be synthesized and displayed.

The lenticular lens 1A splits plural parallax images included in the parallax-synthesized image displayed on the image display device 2 into plural viewpoint directions so as to realize 3D vision, which is arranged to face the image display device 2 with a given positional relation.

The lenticular lens 1A splits plural parallax images included in the parallax synthesized image on the screen of the image display device 2 so that only a specific parallax image is observed when observing the image display device 2 from a specific viewpoint position. Light emitting angles emitted from respective sub-pixels of the image display device 2 are limited from the positional relation between the cylindrical lenses 13 of the lenticular lens 1A and respective sub-pixels of the image display device 2. The respective sub-pixels of the image display device 2 are displayed in different directions according to the positional relation with respect to the cylindrical lenses 13. Light rays L3, L2 from different sub-pixels reach left and right eyes 10L, 10R of the observer and images with parallax are viewed to thereby be perceived as 3D video.

The above lenticlular lens 1A in the 3D image display device can be configured by using the liquid crystal lens array device according to the embodiment. That is, the cylindrical lens 13 as shown in FIG. 1B can be equivalently formed in the structure of the liquid crystal lens array of FIG. 1A, therefore, lens effects equivalent to the lenticular lens 1A can be obtained by arranging a large number of second electrodes 21 in parallel at intervals corresponding to a lens pitch of the cylindrical lenses 13 of the lenticular lens 1A.

### Second Embodiment

Next, a liquid crystal lens array device according to a second embodiment will be explained. The same signs are given to substantially the same components as the liquid crystal lens array device according the first embodiment and explanation will be suitably omitted.

The structure of the liquid crystal lens array device according to the embodiment is the same as FIG. 1A, however, the driving method thereof is different from the first embodiment. The first electrode 11 is in the fixed potential and the phase difference between the two line electrodes formed as the second electrodes 21 can be controlled in the first embodiment, whereas in this embodiment, the rectangular wave is applied also to the first electrode 11, thereby controlling phase differences between the first electrode 11 and the second electrodes 21.

Specific Examples of Drive Waveforms

### First Drive Example

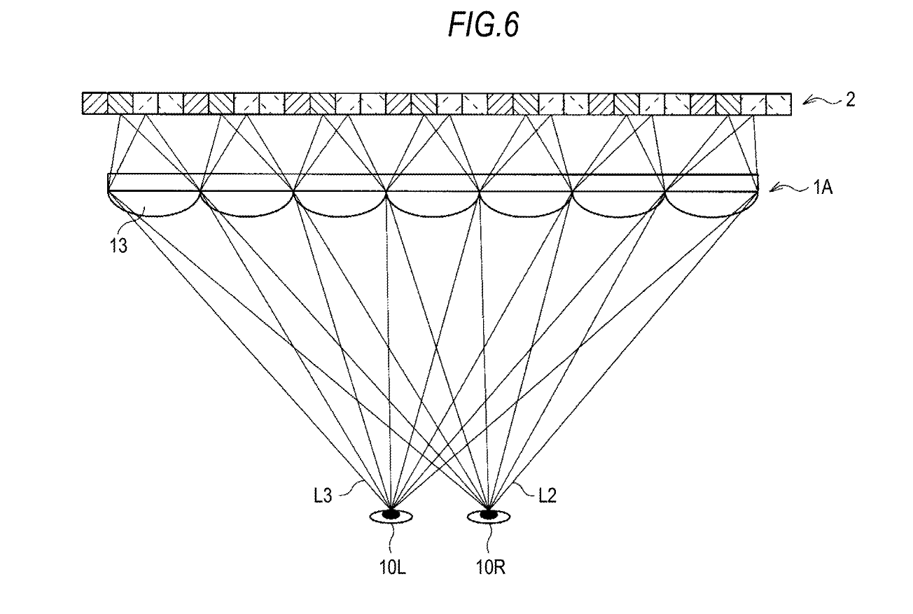

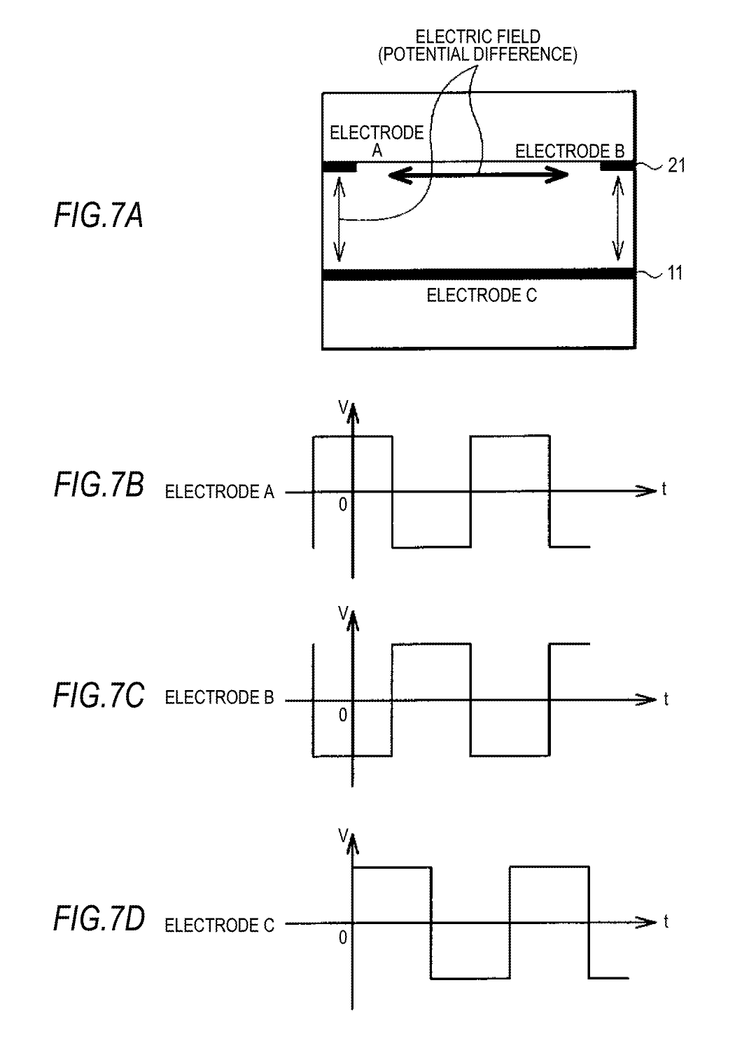

FIG. 7A schematically shows electric field distribution (potential difference distribution) obtained when the liquid crystal lens array device according to the embodiment is driven in a first drive example in the same manner as FIG. 2A. FIG. 7B shows a drive waveform applied to the electrode A when driven in the first drive example and FIG. 7C shows a drive waveform applied to the electrode B when driven in the first drive example. FIG. 7D shows a drive waveform applied to the electrode C when driven in the first drive example.

In the first drive example, a phase of the drive waveform to be given to the electrode A is advanced by 90 degrees and a phase of the drive waveform to be given to the electrode B is delayed by 90 degrees with respect to the electrode C. In this case, phases are completely reversed between the electrode A and the electrode B and the high electric field is applied in the horizontal direction, and not-so-high electric field as in the horizontal direction is applied in the vertical direction.

### Second Drive Example

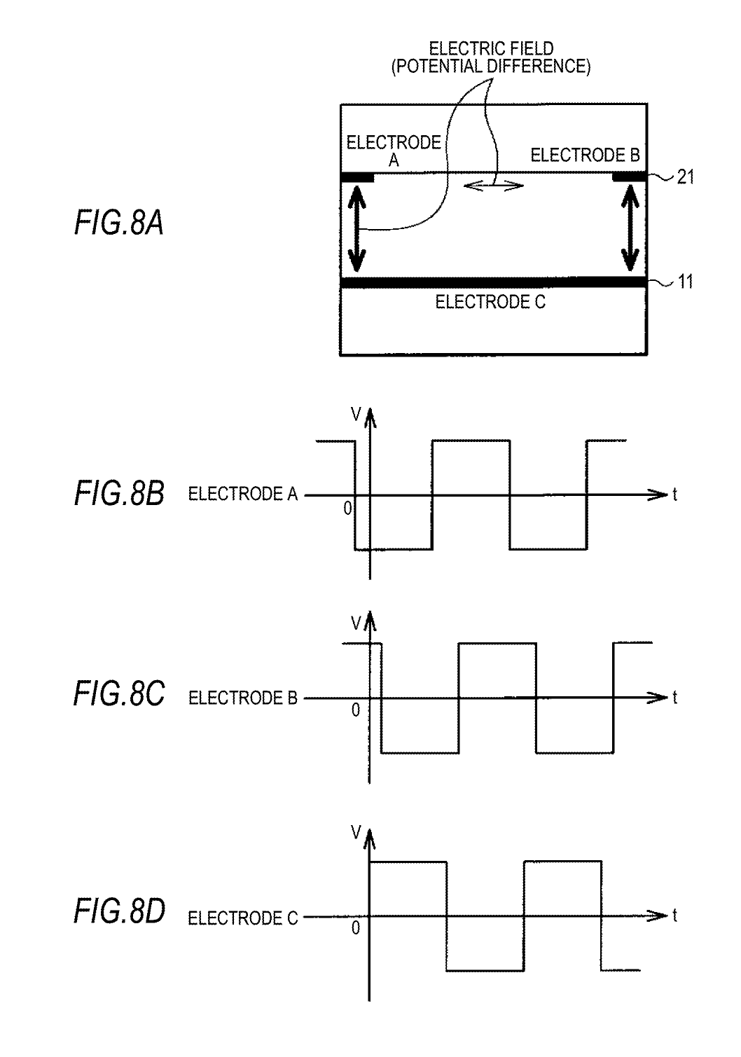

FIG. 8A schematically shows electric field distribution (potential difference distribution) obtained when the liquid crystal lens array device according to the embodiment is driven in a second drive example in the same manner as FIG. 2A. FIG. 8B shows a drive waveform applied to the electrode A when driven in the second drive example and FIG. 8C shows a drive waveform applied to the electrode B when driven in the second drive example. FIG. 8D shows a drive waveform applied to the electrode C when driven in the second drive example.

In the second drive example, a phase of the drive waveform to be given to the electrode A is advanced by 112.5 degrees and a phase of the drive waveform to be given to the electrode B is delayed by 67.5 degrees with respect to the electrode C. In this case, phase shift of merely 45 degrees is generated between the electrode A and the electrode B, therefore, higher electric field is applied in the vertical direction than in the horizontal direction.

### Third Drive Example

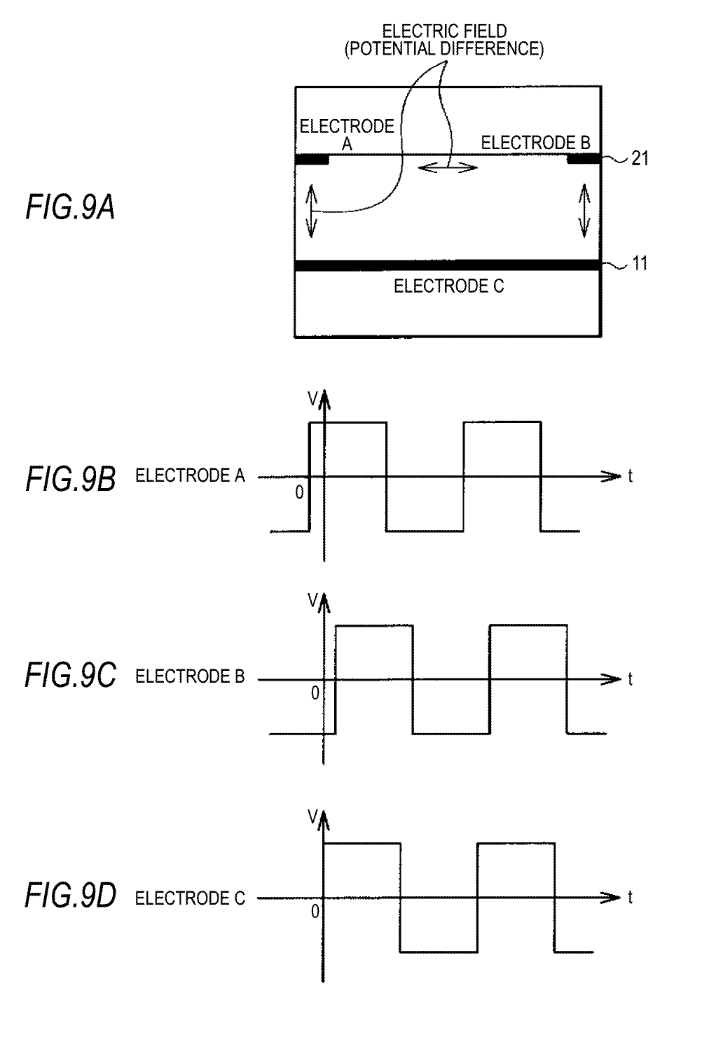

FIG. 9A schematically shows electric field distribution (potential difference distribution) obtained when the liquid crystal lens array device according to the embodiment is driven in a third drive example in the same manner as FIG. 2A. FIG. 9B shows a drive waveform applied to the electrode A when driven in the third drive example and FIG. 9C shows a drive waveform applied to the electrode B when driven in the third drive example. FIG. 9D shows a drive waveform applied to the electrode C when driven in the third drive example.

In the third drive example, a phase of the drive waveform to be given to the electrode A is advanced by 22.5 degrees and a phase of the drive waveform to be given to the electrode B is delayed by 22.5 degrees with respect to the electrode C. In this case, higher electric field is applied in the horizontal direction as compared with in the vertical direction, however, a higher electric field than the drive examples of FIGS. 7A to 7D as well as FIGS. 8A to 8D is not applied in either direction.

As described above, in the liquid crystal lens array device according to the embodiment, not only the phase difference between plural second electrodes 21 but also phase differences between the first electrode 11 and the second electrodes 21 can be controlled, therefore, electric field distributions in the vertical direction and horizontal direction can be controlled respectively.

### Third Embodiment

Next, a liquid crystal lens array device according to a third embodiment will be explained. The same signs are given to substantially the same components as the liquid crystal lens array devices according the first and second embodiments and explanation will be suitably omitted.

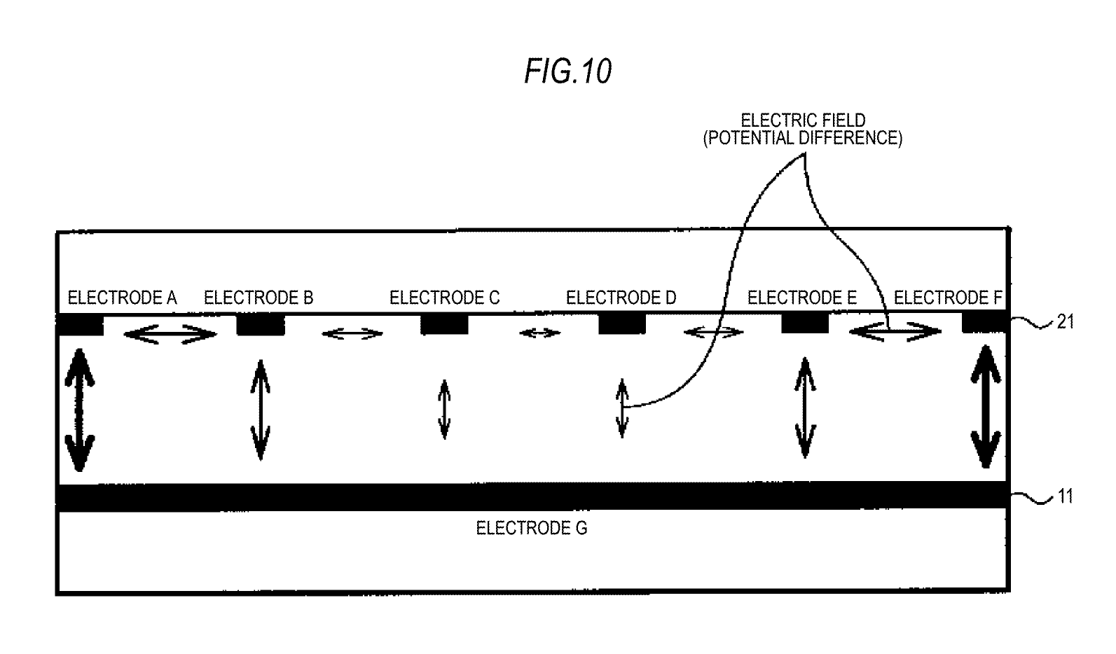

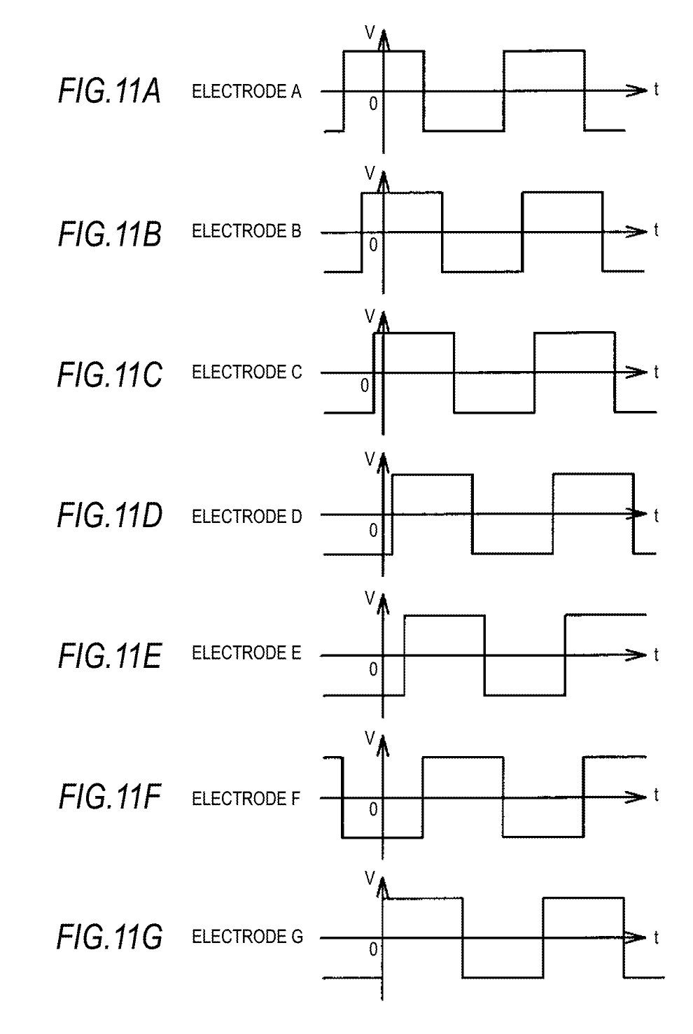

In the first and second embodiments, the example in which the second electrodes 21 are formed as two line electrodes has been shown as shown in FIG. 1A, and it is possible to form the second electrodes 21 as three or more line electrodes. For example, the second electrodes 21 can be formed as, for example, six line electrodes, which are electrodes A to F as shown in FIG. 10. In the structure example of FIG. 10, the first electrode 11 facing the electrodes A to F is formed as an electrode G. FIG. 10 schematically shows electric field distribution obtained when respective electrodes are driven in a first drive example shown in FIGS. 11A to 11G in the same matter as FIG. 2A. In the structure example of FIG. 10, lens effects (refractive power) equivalent to, for example, one cylindrical lens 13 shown in FIG. 1B can be equivalently generated by the six line electrodes of the electrodes A to F and the facing electrodes G.

Specific Examples of Drive Waveforms

### First Drive Example

FIGS. 11A to 11G show drive waveforms applied to respective electrodes of electrodes A to F and the electrode G when the liquid crystal lens array device in the structure example of FIG. 10 is driven in a first drive example. In the first drive example, a phase of the drive waveform to be given to the electrode A is advanced by 90 degrees and a phase of the drive waveform to be given to the electrode F is delayed by 90 degrees with respect to the drive waveform of the electrode G. Additionally, a phase of the drive waveform to be given to the electrode B is advanced by 45 degrees, a phase of the drive waveform to be given to the electrode E is delayed by 45 degrees, a phase of the drive waveform to be given to the electrode C is advanced by 22.5 degrees and a phase of the drive waveform to be given to the electrode D is delayed by 22.5 degrees with respect to the drive waveform of the electrode G.

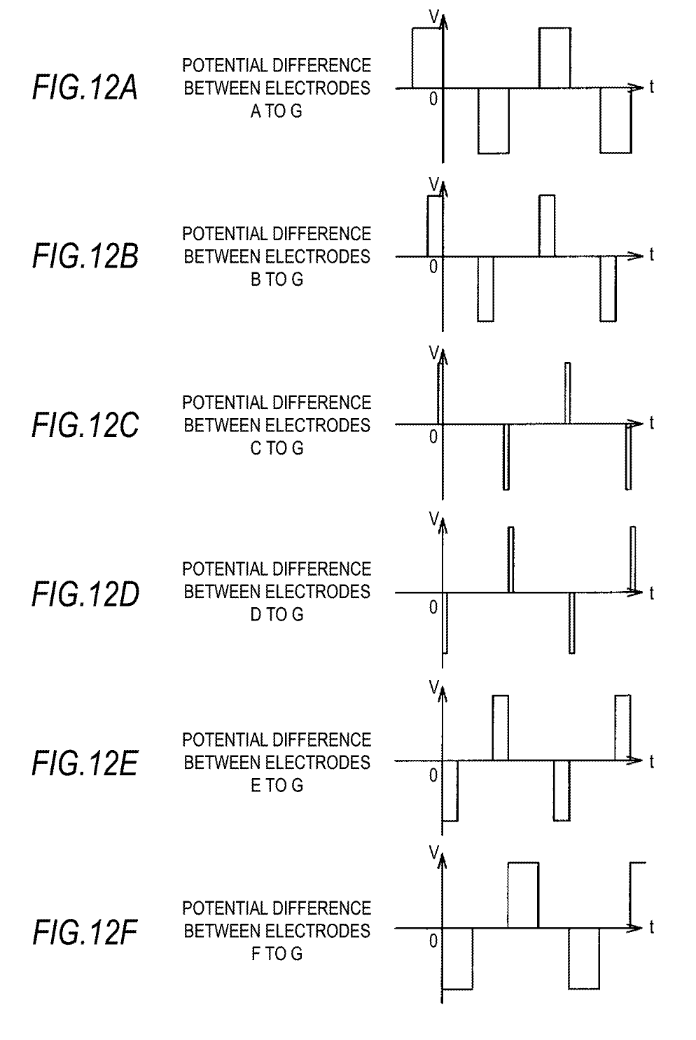

FIGS. 12A to 12F show potential differences generated between two electrodes in the vertical direction when the liquid crystal lens array device in the structure example of FIG. 10 is driven in the first drive example of FIGS. 11A to 11B. Specifically, FIG. 12A shows a potential difference generated between the electrode A and the electrode G, FIG. 12B shows a potential difference generated between the electrode B and the electrode G and FIG. 12C shows a potential difference generated between the electrode C and the electrode G. Additionally, FIG. 12D shows a potential difference generated between the electrode D and the electrode G, FIG. 12E shows a potential difference generated between the electrode E and the electrode G and FIG. 12F shows a potential difference generated between the electrode F and the electrode G.

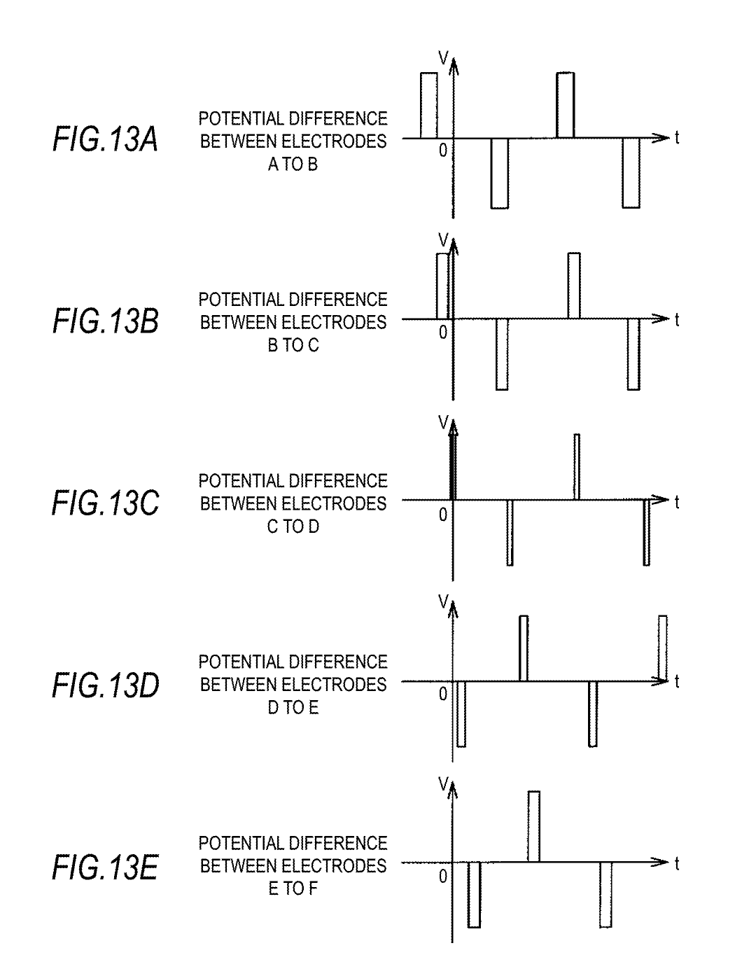

FIGS. 13A to 13E show potential differences generated between two electrodes in the horizontal direction when the liquid crystal lens array device in the structure example of FIG. 10 is driven in the first drive example of FIGS. 11A to 11G. Specifically, FIG. 13A shows a potential difference generated between the electrode A and the electrode B, FIG. 13B shows a potential difference generated between the electrode B and the electrode C and FIG. 13C shows a potential difference generated between the electrode C and the electrode D. Additionally, FIG. 13D shows a potential difference generated between the electrode D and the electrode E and FIG. 13E shows a potential difference generated between the electrode E and the electrode F.

### Second Drive Example

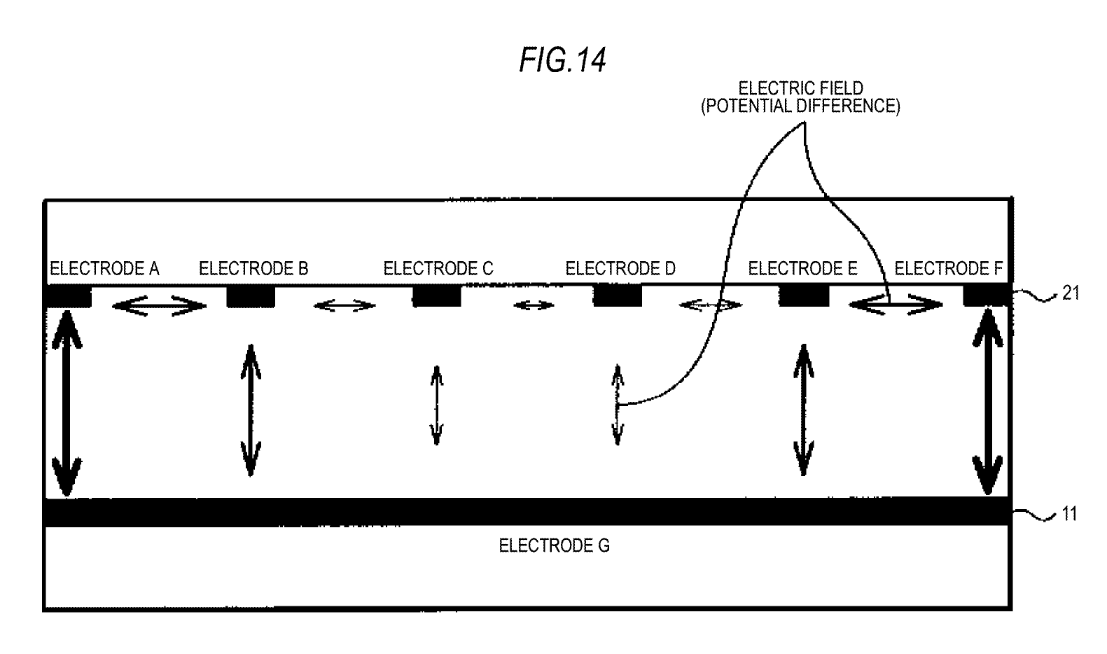

FIG. 14 schematically shows electric field distribution (potential difference distribution obtained when the liquid crystal lens array device according to the embodiment is drive in the second drive example in the same manner as FIG. 2A. In the second drive example, the lens effects equivalent to the structure example of FIG. 10 can be obtained by adjusting the drive waveform applied to respective electrodes even when the thickness of the liquid crystal layer 3 is increased as shown in FIG. 14 as compared with the structure example of FIG. 10.

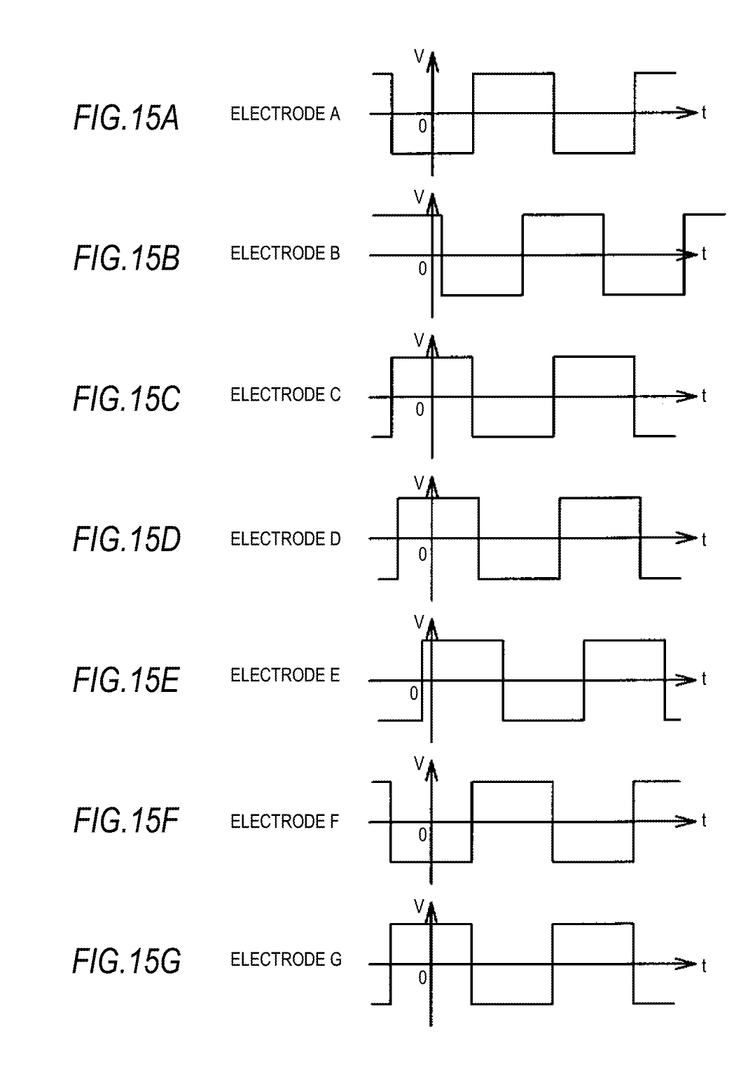

FIGS. 15A to 15G show drive waveforms applied to respective electrodes of electrodes A to F and the electrode G when the liquid crystal lens array device in the structure example of FIG. 14 is driven in the second drive example. According to the second drive example, the lens effects equivalent to the case in which respective electrodes are driven by the drive waveforms shown in FIGS. 11A to 11G in the structure example of FIG. 10 even when the thickness of the liquid crystal layer 3 is increased. The phase differences corresponding to thickness variations with respect to respective waveforms of FIGS. 11A to 11G are given to drive waveforms given to respective electrodes.

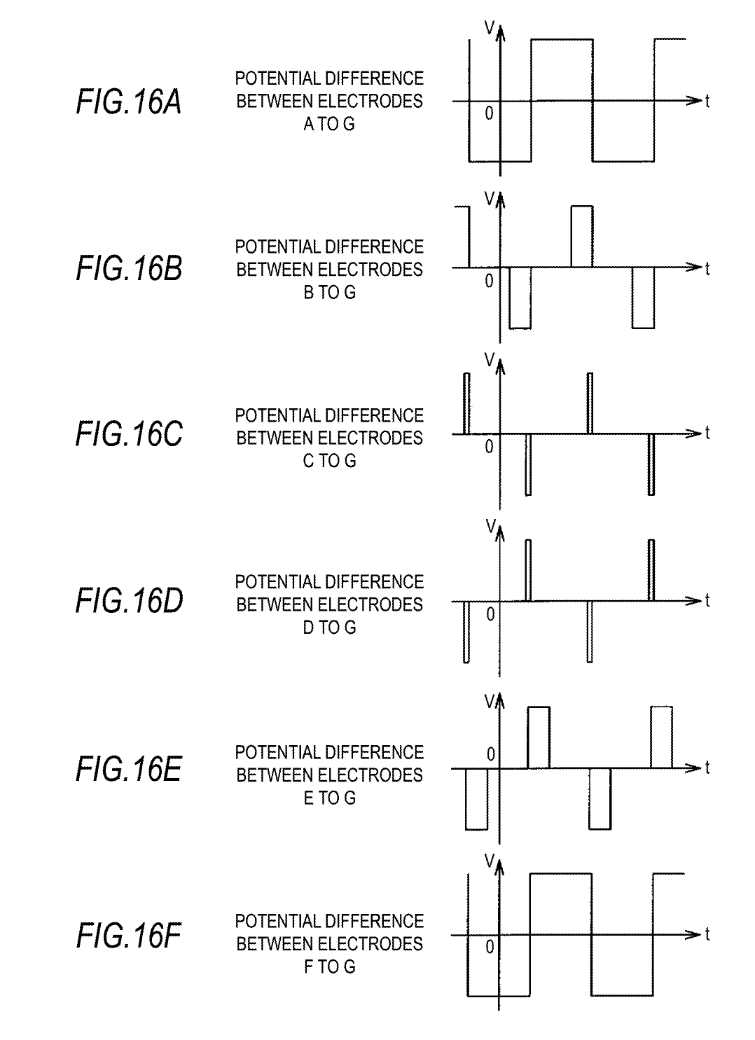

FIGS. 16A to 16F show potential differences generated between two electrodes in the vertical direction when the liquid crystal lens array device in the structure example of FIG. 14 is driven in the second drive example of FIGS. 15A to 15G. Specifically, FIG. 16A shows a potential difference generated between the electrode A and the electrode G, FIG. 16B shows a potential difference generated between the electrode B and the electrode G and FIG. 16C shows a potential difference generated between the electrode C and the electrode G. Additionally, FIG. 16D shows a potential difference generated between the electrode D and the electrode G, FIG. 16E shows a potential difference generated between the electrode E and the electrode G and FIG. 16F shows a potential difference generated between the electrode F and the electrode G.

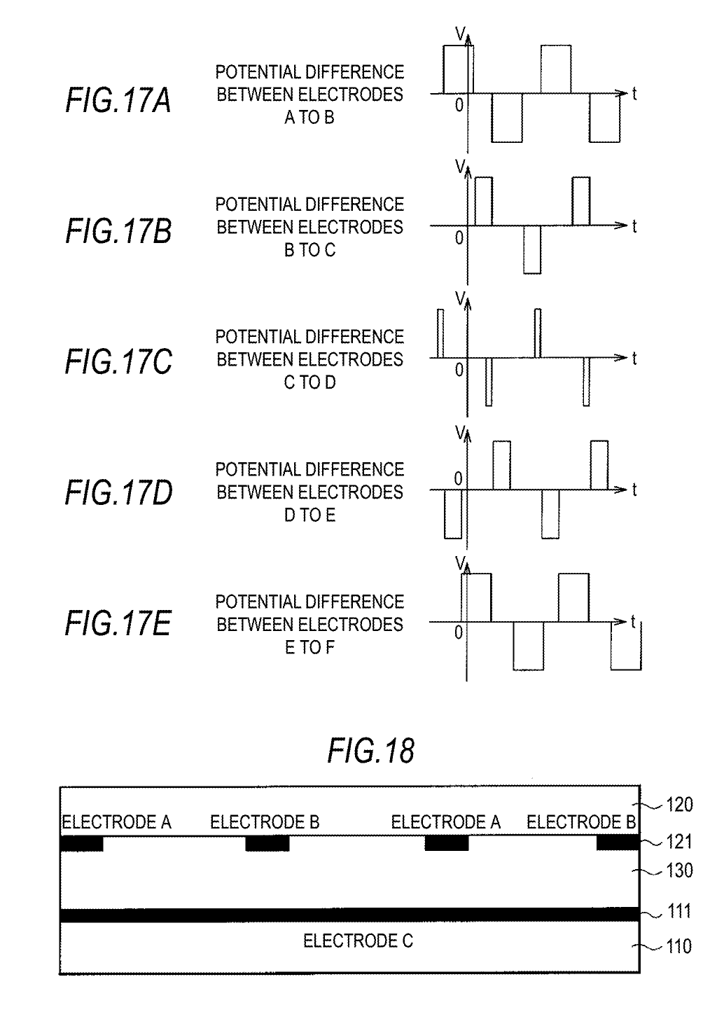

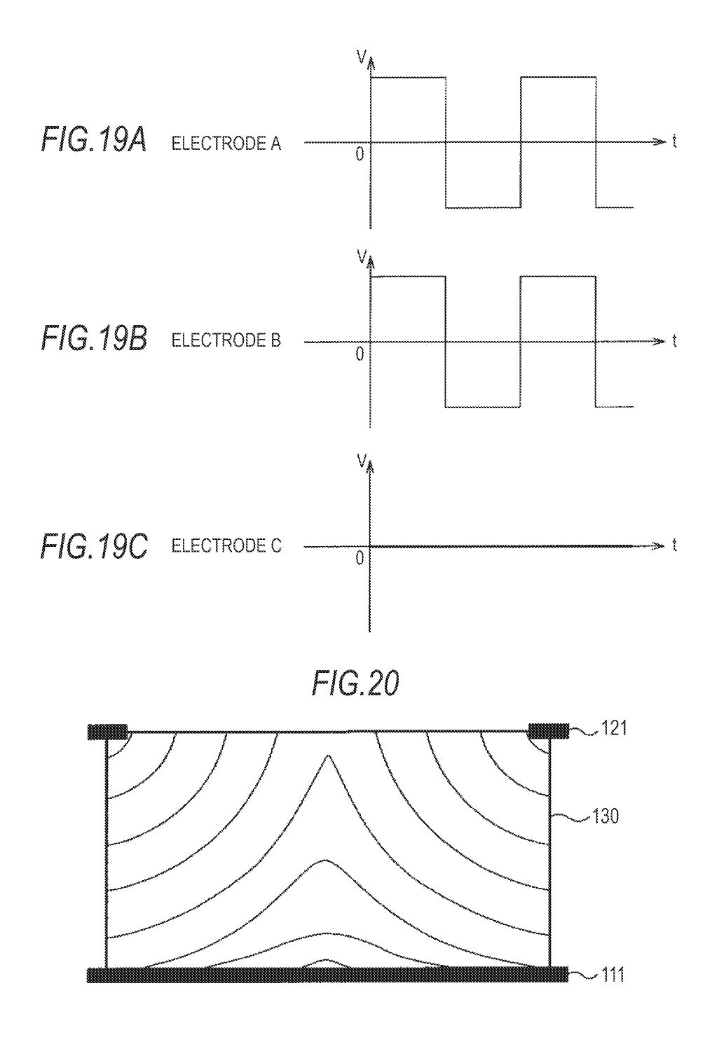

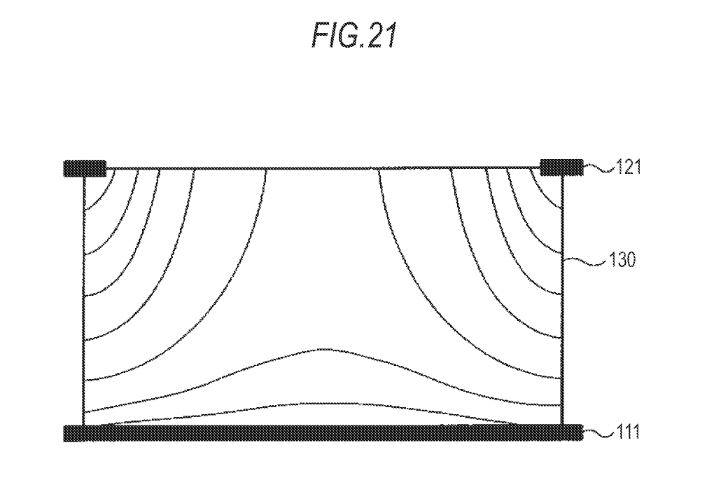

FIGS. 17A to 17E show potential differences generated between two electrodes in the horizontal direction when the liquid crystal lens array device in the structure example of FIG. 14 is driven in the second drive example of FIGS. 15A to 15G. Specifically, FIG. 17A shows a potential difference generated between the electrode A and the electrode B, FIG. 17B shows a potential difference generated between the electrode B and the electrode C and FIG. 17C shows a potential difference generated between the electrode C and the electrode D. Additionally, FIG. 17D shows a potential difference generated between the electrode D and the electrode E and FIG. 17E shows a potential difference generated between the electrode E and the electrode F.

### Other Embodiments

The present application is not limited to explanations of the above respective examples and various modifications can be performed.

For example, the case where the drive waveforms are rectangular waves has been cited in the explanations of the above embodiments, however, the electric field distribution can be controlled based on the same concept by shifting the phase with respect to driving in waveforms not only the rectangular wave but also waveforms such as a sine wave and a saw tooth wave.

The first electrode 11 is formed on the first substrate 10 on the side facing the second substrate 20 (the side of liquid crystal layer 3) in the respective embodiments, however, the first substrate 11 can be formed on the first substrate 10 on the side not facing the second substrate 20 (opposite side of the liquid crystal layer 3). Similarly, the second substrates 21 can be formed on the second substrate 20 on the side not facing the first substrate 10 (opposite side of the liquid crystal layer 3), not the side on the second substrate 20 on the side facing the first substrate 10.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A liquid crystal lens array device comprising:
a first electrode;
a plurality of second electrodes arranged to face the first electrode, to which drive voltages having waveforms with phase differences therebetween are applied; and
a liquid crystal layer arranged between the first electrode and the plural second electrodes, generating lens effects in accordance with potential differences between the drive voltage applied to the first electrode and drive voltages applied to the plural second electrodes.

2. The liquid crystal lens array device according to claim 1,
wherein the phase difference between drive voltages applied to the respective plural second electrodes is variable.

3. The liquid crystal lens array device according to claim 1,
wherein drive voltages having waveforms with phase differences with respect to drive voltages to be applied to the respective plural electrodes are applied to the first electrode.

4. The liquid crystal lens array device according to claim 3,
wherein the phase difference between the drive voltage applied to the first electrode and each of the drive voltages applied to the respective plural second electrodes is variable.

5. A method of driving a liquid crystal lens array device having
a first electrode,
a plurality of second electrodes arranged to face the first electrode, and
a liquid crystal layer arranged between the first electrode and the plural second electrodes, generating lens effects in accordance with potential differences between the drive voltage applied to the first electrode and drive voltages applied to the plural second electrodes, the method comprising:
applying drive voltages having waveforms with phase differences therebetween to the respective plural second electrodes.

6. The method of the liquid crystal lens array device according to claim 5,
wherein lens effects generated in the liquid crystal layer are controlled by changing the phase difference between drive voltages applied to the respective plural second electrodes.

7. An image display device comprising:
a display unit; and
a liquid crystal lens array device arranged to face the display unit,
wherein the liquid crystal lens array includes
a first electrode,
a plurality of second electrodes arranged to face the first electrode, to which drive voltages having waveforms with phase differences therebetween are applied, and
a liquid crystal layer arranged between the first electrode and the plural second electrodes, generating lens effects in accordance with potential differences between the drive voltage applied to the first electrode and drive voltages applied to the plural second electrodes.

8. An optical device comprising:
a liquid crystal layer;
a first electrode; and
a plurality of second electrodes arranged to face the first electrode with a the liquid crystal layer sandwiched therebetween, to which drive voltages having waveforms with phase differences therebetween are applied,
wherein the liquid crystal layer generates lens effects in accordance with the drive voltages.
